(19) United States
(12) Patent Application Publication
(10) Pub. No.: US 2026/0326144 A1
(43) Pub. Date: Oct. 22, 2026

(54) VISCOUS MATERIAL DISPENSING SYSTEM AND COMPRESSIBLE CONTAINER ASSEMBLY FOR SAME

(71) Applicant: DAP Global Inc., Baltimore, MD (US)

(72) Inventors: James Kenney, Baltimore, MD (US); Louis Vasiliades, Baltimore, MD (US)

(21) Appl. No.: 19/648,842

(22) Filed: Apr. 15, 2026

Related U.S. Application Data
(60) Provisional application No. 63/789,604, filed on Apr. 16, 2025.
(60) Provisional application No. 63/789,612, filed on Apr. 16, 2025.

(51) Int. Cl. B05C 17/005

(52) U.S. Cl. CPC B05C 17/00573; B05C 17/00583

(57) ABSTRACT

Described herein are a viscous material dispensing system and a compressible container assembly for same. The viscous material dispensing system includes a pressure vessel including a lid that is fluidically connected to an applicator by a flexible tube. The pressure vessel is sealable by the lid and configured to receive a pressurized fluid when sealed by the lid. The lid is fluidically connectable to the compressible container assembly. The compressible container assembly includes a compressible container including a viscous material disposed therein. When the lid has been fluidically connected to the compressible container assembly and the pressure vessel has received the pressurized fluid, the pressurized fluid compresses the compressible container and actuation of the applicator dispenses a portion of the viscous material from the actuator in a liquid form. Also described herein are methods of using the viscous material dispensing system and the compressible container assembly.

### CROSS-REFERENCE TO RELATED APPLICATIONS

This application claims priority to U.S. Provisional Patent Application No. 63/789,604, filed Apr. 16, 2025, and also claims priority to U.S. Provisional Patent Application No. 63/789612, filed Apr. 16, 2025, the contents of which are hereby incorporated by reference herein.

### FIELD OF DISCLOSURE

The present disclosure is directed to a viscous material dispensing system and a compressible container assembly. The viscous material dispensing system includes a pressure vessel including a lid that is fluidically connected to an applicator by a flexible tube. The pressure vessel is sealable by the lid and configured to receive a pressurized fluid when sealed by the lid. The lid is fluidically connectable to the compressible container assembly. The compressible container assembly includes a compressible container including a viscous material disposed therein. When the lid has been fluidically connected to the compressible container assembly and the pressure vessel has received the pressurized fluid, the pressurized fluid compresses the compressible container and actuation of the applicator dispenses a portion of the viscous material from the actuator in a liquid form. The present disclosure is further directed to methods of using the viscous material dispensing system and the compressible container assembly.

### BACKGROUND

Viscous materials may be dispensed from a variety of viscous material dispensing systems. For example, caulks may be dispensed from caulking guns or pneumatic caulking guns.

However, conventional viscous material dispensing systems are unsatisfactory in several regards. For example, many conventional viscous material dispensing systems have throughputs that are limited by the size of containers containing the viscous material, the flowability of the viscous materials, or the ease of loading different viscous materials into the viscous material dispensing systems. Further, many conventional viscous material dispensing systems that are high-throughput lack portability, as they require a constant connection to an air compressor. Further, many conventional viscous material dispensing systems that are high-throughput are difficult to clean up, as the viscous materials come into physical contact with the viscous material dispensing systems and therefore require time-consuming cleaning. Still further, many conventional viscous material dispensing systems exhibit material cavitation when utilizing conventional dip tubes. Thus, there is no single conventional viscous material dispensing system that is high-throughput, portable, and easy to clean up.

Accordingly, there is a need for a viscous material dispensing system that is high-throughput, portable, and easy to clean up.

### BRIEF DESCRIPTION OF THE DISCLOSURE

In one embodiment of the present disclosure, provided herein is a viscous material dispensing system including a pressure vessel including a lid that is fluidically connected to an applicator by a flexible tube. The pressure vessel is sealable by the lid and configured to receive a pressurized fluid when sealed by the lid. The lid is fluidically connectable to a compressible container assembly including a compressible container including a viscous material disposed therein. When the lid has been fluidically connected to the compressible container assembly and the pressure vessel has received the pressurized fluid, the pressurized fluid compresses the compressible container and actuation of the applicator dispenses a portion of the viscous material from the actuator in a liquid form.

In another embodiment of the present disclosure, provided herein is a method of using a viscous material dispensing system. The viscous material dispensing system includes a pressure vessel including a lid that is fluidically connected to an applicator by a flexible tube. The pressure vessel is sealable by the lid and configured to receive a pressurized fluid when sealed by the lid. The lid is fluidically connectable to a compressible container assembly including a compressible container including a viscous material disposed therein. When the lid has been fluidically connected to the compressible container assembly and the pressure vessel has received the pressurized fluid, the pressurized fluid compresses the compressible container and actuation of the applicator dispenses a portion of the viscous material from the actuator in a liquid form. The method includes using the viscous material dispensing system to dispense the viscous material in the liquid form onto a target surface.

In another embodiment of the present disclosure, provided herein is a compressible container assembly. The compressible container assembly includes a tube including a plurality of perforations and a compressible container. The compressible container includes a spout, an internal volume formed between walls of the compressible container, and a viscous material disposed in the internal volume. The compressible container is configured to receive a portion of the tube through the spout. A portion of the viscous material is forced out of the compressible container upon compression of the compressible container. The tube is configured to prevent a portion of the compressible container from collapsing upon compression of the compressible container.

In yet another embodiment of the present disclosure, provided herein is a method of using a compressible container assembly. The compressible container assembly includes a tube including a plurality of perforations and a compressible container. The compressible container includes a spout, an internal volume formed between walls of the compressible container, and a viscous material disposed in the internal volume. The compressible container is configured to receive a portion of the tube through the spout. A portion of the viscous material is forced out of the compressible container upon compression of the compressible container. The tube is configured to prevent a portion of the compressible container from collapsing upon compression of the compressible container. The method includes using the compressible container assembly to provide the viscous material to a viscous material dispensing system.

### BRIEF DESCRIPTION OF THE DRAWINGS

The following figures are examples of viscous material dispensing systems in accordance with the present disclosure and are not to be construed as limiting.

Various example embodiments may be more completely understood in consideration of the following detailed description and in connection with the accompanying drawings, in which:

FIG. 1 shows a perspective view of an exemplary viscous material dispensing system in accordance with the present disclosure.

FIG. 2 shows an exploded view of an exemplary viscous material dispensing system in accordance with the present disclosure.

FIG. 3 shows an exploded view of an exemplary compressible container assembly in accordance with the present disclosure.

FIG. 4 shows a perspective view of an exemplary partially assembled viscous material dispensing system in accordance with the present disclosure.

FIG. 5 shows an exploded view of an exemplary cleaning configuration for the viscous material dispensing system in accordance with the present disclosure.

### DETAILED DESCRIPTION

While various embodiments discussed herein are amenable to modifications and alternative forms, aspects thereof have been shown by way of example in the drawings and will be described in detail. It should be understood, however, that the intention is not to limit the invention of the particular embodiments described. On the contrary, the intention is to cover all modifications, equivalents, and alternatives falling within the scope of the disclosure including aspects defined in the claims.

It should also be understood that the various embodiments discussed herein are combinable. As such, the intention of the discussions is not to limit the invention of the particular embodiments described. On the contrary, the intention is to cover all modifications, equivalents, and alternatives falling within the scope of the disclosure including aspects defined in the claims.

Described herein is a viscous material dispensing system including a pressure vessel including a lid that is fluidically connected to an applicator by a flexible tube. The pressure vessel is sealable by the lid and configured to receive a pressurized fluid when sealed by the lid. The lid is fluidically connectable to a compressible container assembly including a compressible container including a viscous material disposed therein. When the lid has been fluidically connected to the compressible container assembly and the pressure vessel has received the pressurized fluid, the pressurized fluid compresses the compressible container and actuation of the applicator dispenses a portion of the viscous material from the actuator in a liquid form.

As used herein, the term “has been” means that the recited aspect is configured before functionality is achieved. If the aspect is not configured as recited, then the recited functionality is not achieved. For example, when the lid has not been fluidically connected to the compressible container assembly and the pressure vessel has not received the pressurized fluid, the pressurized fluid does not compress the compressible container. Similarly, when the lid has not been fluidically connected to the compressible container assembly and the pressure vessel has not received the pressurized fluid, actuation of the applicator does not dispense a portion of the viscous material from the actuator in a liquid form. The term “has been” therefore reflects functionality but does not constitute a positive method step.

As used herein, the term “fluidically connectable” means the ability to connect the recited components such that fluid is able to flow from one component to another. This term does not require or exclude the components being physically connectable. In some embodiments, the recited components are fluidically connected. In some embodiments, the recited components are not fluidically connected.

As used herein, the term “physically connectable” means the ability to connect the recited components such that the components are physically coupled together. This term does not require or exclude the components being fluidically connectable. In some embodiments, the recited components are physically connected. In some embodiments, the recited components are physically connected with a configuration selected from the group consisting of physical couplings, screw couplings, threaded couplings, snap couplings, rotatable couplings, quick-connect couplings, rotably detented couplings, inserting couplings, adhesives, moldings, overmoldings, and combinations thereof. In some embodiments, the recited components are not physically connected.

As used herein, the term “compressible” means the ability for the recited component to be compressed. The recited component may be compressed by any known pressure force, including hydrostatic forces, mechanical forces, and combinations thereof.

As used herein, the term “sealable” means the ability for the recited component to be sealed. The sealable component may be pressurized once sealed. In some embodiments, the recited component is sealed. In some embodiments, the recited component is not sealed.

As used herein, the term “liquid form” means that the viscous material is dispensed from the viscous material dispensing system as a liquid. The viscous material may be a Newtonian liquid or a non-Newtonian liquid. The liquid form does not include substantial mixtures with gas for dispensing (i.e., atomized or nebulized liquids, mists, or sprays).

Generally, the viscous material dispensing system may include any viscous material known in the art suitable to facilitate the viscous material dispensing system. In many embodiments, the viscous material has certain fluidic properties sufficient to facilitate dispensing of the viscous material. Certain fluidic properties are required to dispense viscous materials at the operating conditions (e.g., pressures) of the viscous material dispensing system.

In some embodiments, one or more of the fluidic properties is measured with a parallel plate rheometer with 25 mm roughened plates, running a shear rate ramp from 0 s⁻¹ to 100 s⁻¹.

In some embodiments, the viscous material has a viscosity such that it is pumpable but does not run or drip when applied in vertical and overhead applications.

In some embodiments, the viscous material has a dynamic viscosity in a range of from about 10 Pa*s to about 50 Pa*s. In some embodiments, the viscous material has a dynamic viscosity in a range of from about 50 Pa*s to about 150 Pa*s. In some embodiments, the viscous material has a dynamic viscosity in a range of from about 100 Pa*s to about 300 Pa*s. As used herein a “dynamic viscosity” refers to a viscosity measured at a shear of 10 s⁻¹.

In some embodiments, the viscous material has a static viscosity in a range of from about 150 Pa*s to about 250 Pa*s. In some embodiments, the viscous material has a static viscosity in a range of from about 220 Pa*s to about 500 Pa*s. In some embodiments, the viscous material has a static viscosity in a range of from about 450 Pa*s to about 1000 Pa*s. As used herein a “static viscosity” refers to a viscosity measured at a shear of 0.01 s⁻¹ or below.

In some embodiments, the viscous material has a yield stress less than about 0.10 Pa. In some embodiments, the viscous material has a yield stress less than about 300 Pa. In some embodiments, the viscous material has a yield stress less than about 160 Pa.

In some embodiments, the viscous material has a yield stress less than about 302 Pa, less than about 283 Pa, less than about 279 Pa, less than about 270 Pa, less than about 260 Pa, less than about 251 Pa, less than about 239 Pa, less than about 233 Pa, less than about 191 Pa, less than about 166 Pa, less than about 154 Pa, less than about 125 Pa, less than about 98 Pa, less than about 78 Pa, less than about 62 Pa, less than about 44 Pa, less than about 44 Pa, less than about 0.327 Pa, less than about 0.295 Pa, less than about 0.273 Pa, less than about 0.232 Pa, less than about 0.228 Pa, less than about 0.201 Pa, less than about 0.189 Pa, less than about 0.184 Pa, less than about 0.181 Pa, less than about 0.168 Pa, less than about 0.153 Pa, less than about 0.131 Pa, less than about 0.128 Pa, less than about 0.121 Pa, or less than about 0.115 Pa.

In some embodiments, the viscous material has a yield viscosity less than about 259 Pa*s. In some embodiments, the viscous material has a yield viscosity less than about 194 Pa*s. In some embodiments, the viscous material has a yield viscosity less than about 147 Pa*s. In some embodiments, the viscous material has a yield viscosity less than about 117 Pa*s. In some embodiments, the viscous material has a yield viscosity less than about 96 Pa*s. In some embodiments, the viscous material has a yield viscosity less than about 70 Pa*s. In some embodiments, the viscous material has a yield viscosity less than about 41 Pa*s. In some embodiments, the viscous material has a yield viscosity less than about 22 Pa*s. In some embodiments, the viscous material has a yield viscosity less than about 9 Pa*s. In some embodiments, the viscous material has a yield viscosity less than about 5 Pa*s. In some embodiments, the viscous material has a yield viscosity less than about 0.38 Pa*s.

In some embodiments, the viscous material includes a fluidic property under atmospheric pressure selected from the group consisting of:
a dynamic viscosity in a range of from about 15 Pa*s to about 70 Pa*s;
a static viscosity in a range of from about 175 Pa*s to about 700 Pa*s;
a yield viscosity less than about 100 Pa*s;
a yield stress less than about 300 Pa;
and combinations thereof.

In some embodiments, the viscous material is self-tooling. As used herein, the term “self-tooling” means that the shrinkage upon application is such that on a 90-degree fillet bead, the viscous material will achieve a concave configuration typically seen in tooled beads without manual tooling. In these embodiments, it is understood that tooling is not necessary to achieve a final surface. Natural shrinkage during cure will leave a flat or concave bead. It is further understood that tooling may still be performed without negative effects if desired.

In some embodiments, the viscous material is selected from the group consisting of curing compositions, one-component curing compositions, two-component curing compositions, three-component curing compositions, multi-component curing compositions, caulks, sealants, adhesives, and combinations thereof.

In many embodiments, when the viscous material includes a multi-component curing composition (e.g., two-component or three-component curing compositions), the individual components of the multi-component curing composition are separately provided within the viscous material dispensing system. In these embodiments, the individual components of the multi-component curing composition remain separated until combined within the viscous material dispensing system.

In some embodiments, the viscous material includes a component selected from the group consisting of sealant polymers, rheological additives, organic thickening agents, inorganic thickening agents, shear thinning thickening agents, pseudoplastic thickening agents, adhesion promoters, adhesives, pigments, dispersants, pigment dispersants, filler dispersants, fillers, detergents, non-ionic detergents, cationic detergents, anionic detergents, surfactants, non-ionic surfactants, cationic surfactants, anionic surfactants, biocides, mildew growth inhibitors, plasticizers, oils, process oils, freeze-thaw additives, volatile freeze-thaw additives, non-volatile freeze-thaw additives, pH modifiers, volatile pH modifiers, non-volatile pH modifiers, buffers, coalescing agents, defoamers, stabilizers, solvents, water, and combinations thereof.

In some embodiments, the viscous material includes a sealant polymer.

In some embodiments, the viscous material includes:
a sealant polymer; and
optionally a component selected from the group consisting of rheological additives, organic thickening agents, inorganic thickening agents, shear thinning thickening agents, pseudoplastic thickening agents, adhesion promoters, adhesives, pigments, dispersants, pigment dispersants, filler dispersants, fillers, detergents, non-ionic detergents, cationic detergents, anionic detergents, surfactants, non-ionic surfactants, cationic surfactants, anionic surfactants, biocides, mildew growth inhibitors, plasticizers, oils, process oils, freeze-thaw additives, volatile freeze-thaw additives, non-volatile freeze-thaw additives, pH modifiers, volatile pH modifiers, non-volatile pH modifiers, buffers, coalescing agents, defoamers, stabilizers, solvents, water, and combinations thereof.

As used herein a “sealant polymer” is a polymer that is useful as a sealant. In some embodiments, the sealant binder composition includes one sealant polymer. In some embodiments, the sealant binder composition includes at least two sealant polymers. In some embodiments, the sealant binder composition includes three or more sealant polymers.

In some embodiments, the sealant polymer is selected from the group consisting of polyacrylates, polyurethanes, polyisocyanates, and combinations thereof.

In some embodiments, the viscous material is water-based. In some embodiments, the viscous material includes water.

In some embodiments, the viscous material is oil-based. In some embodiments, the viscous material includes oil.

Generally, the pressurized fluid may be pressurized at any pressure known in the art suitable to facilitate the viscous material dispensing system. In some embodiments, the pressurized fluid has a pressure in a range of from about 69,000 Pa to about 415,000 Pa. In some embodiments, the pressurized fluid has a pressure in a range of from about 125,000 Pa to about 350,000 Pa.

In some embodiments, the pressurized fluid has a pressure of at least about 69,000 Pa, at least about 75,000 Pa, at least about 100,000 Pa, at least about 125,000 Pa, at least about 150,000 Pa, at least about 175,000 Pa, at least about 200,000 Pa, at least about 225,000 Pa, at least about 250,000 Pa, at least about 275,000 Pa, at least about 300,000 Pa, at least about 325,000 Pa, at least about 350,000 Pa, at least about 375,000 Pa, or at least about 400,000 Pa. In some embodiments, the pressurized fluid has a pressure of most about 75,000 Pa, at most about 100,000 Pa, at most about 125,000 Pa, at most about 150,000 Pa, at most about 175,000 Pa, at most about 200,000 Pa, at most about 225,000 Pa, at most about 250,000 Pa, at most about 275,000 Pa, at most about 300,000 Pa, at most about 325,000 Pa, at most about 350,000 Pa, at most about 375,000 Pa, at most about 400,000 Pa, or at most about 415,000 Pa.

In some embodiments, the pressurized fluid has a decreasing pressure during operation of the viscous material dispensing system. In these embodiments, the viscous material dispensing system is pressurized to an initial pressure before dispensing the viscous material, but is not subsequently repressurized during dispensing. The viscous material dispensing system may be repressurized automatically or manually once the initial pressure decreases to a minimum threshold pressure.

In some embodiments, the pressurized fluid has a constant pressure during operation of the viscous material dispensing system. In these embodiments, the viscous material dispensing system is pressurized to an initial pressure before dispensing the viscous material, and is continuously supplied with additional pressure during dispensing in order to maintain a constant pressure during dispensing.

In many embodiments, the viscous material dispensing system includes a pressure relief mechanism to relieve pressure within the viscous material dispensing system. In some embodiments, the pressure relief mechanism is configured to reduce a portion of the pressure within the viscous material dispensing system. In some embodiments, the pressure relief mechanism is configured to reduce the pressure within the viscous material dispensing system to ambient pressure. In some embodiments, the pressure relief mechanism is configured to reduce the pressure within the viscous material dispensing system to ambient pressure as part of a single operation to unseal the lid.

In many embodiments, the pressure vessel is not in fluidic connection with the viscous material or in physical contact with the viscous material. In these embodiments, the pressure vessel receives the compressible container and the pressurized fluid. The sealed pressure vessel facilitates an increase in pressure from the pressurized fluid, which compresses the compressible container.

In some embodiments, the pressurized fluid is selected from the group consisting of compressed air, compressed gas, compressed liquid, compressed CO₂, propellants, and combinations thereof.

In some embodiments, when the pressurized fluid includes a compressed gas, the viscous material dispensing system includes a fluid compressor. In these embodiments, the fluid compressor is contained within the viscous material dispensing system and is not located external to the viscous material dispensing system.

In some embodiments, when the pressurized fluid includes a compressed gas, the pressurized fluid is provided to the viscous material dispensing system from an external fluid compressor. In these embodiments, the fluid compressor is located external to the viscous material dispensing system and is not contained within the viscous material dispensing system.

Generally, any suitable propellant known in the art may be used in the viscous material dispensing system. Suitable propellants known in the art are capable of delivering a variety of materials, including viscous materials. In some embodiments, the propellant includes a propellant selected from the group consisting of hydrocarbon propellants, A-85 propellant, ether propellants, dimethyl ether (DME) propellant, chlorofluorocarbon (CFC) propellants, hydrofluoroolefin (HFO) propellants, hydrofluorocarbons (HFC), and combinations thereof.

In some embodiments, the viscous material dispensing system includes a component requiring power. The component requiring power may be turned on or off or adjusted with a switch, knob, or other suitable mechanism. In some embodiments, the viscous material dispensing system includes a component requiring power selected from the group consisting of fluid compressors, indicators, light emitting diode (LED) indicators, sensors, internal electronics, motors, and combinations thereof.

In some embodiments, the viscous material dispensing system is configured to receive power from a power source selected from the group consisting of batteries, rechargeable batteries, non-rechargeable batteries, removable batteries, non-removable batteries, electrical outlets, renewable power sources, and combinations thereof.

In some embodiments, the viscous material dispensing system is cleanable without physical contact of the viscous material by a user. In these embodiments, the viscous material dispensing system possesses facile cleanability. In these embodiments, the lid is fluidically connectable to a cleaning tube and the cleaning tube is fluidically connectable to a solvent source selected from the group consisting of water outlets, water containers, solvent outlets, solvent containers, and combinations thereof. In some embodiments, the solvent source is provided from a pressurized solvent source and/or from a compressible container.

As used herein, the term “cleanable” means the ability for the recited component to be cleaned. The recited component may be cleaned by any known cleaning technique, including washing with water and/or a solvent. This term does not require or exclude physical contact or mechanical cleaning (e.g., scrubbing) of the recited component.

In some embodiments, the viscous material dispensing system is cleanable according to a method including: fluidically connecting the lid to a cleaning tube, fluidically connecting the cleaning tube to a solvent source selected from the group consisting of water outlets, water containers, solvent outlets, solvent containers, and combinations thereof; and flowing solvent from the solvent source to remove viscous material from the flexible tube and applicator.

In some embodiments, the water outlet is selected from the group consisting of sinks, hoses, and combinations thereof.

In some embodiments, a user may visually determine that the viscous material dispensing system is clean. In some embodiments, the flexible tube is transparent and a user may visually determine that the viscous material dispensing system is clean when the flexible tube is free of viscous material.

In some embodiments, the viscous material dispensing system is portable. In these embodiments, the viscous material dispensing system is able to be freely transported to different locations by an individual user. In some embodiments, the viscous material dispensing system is able to be freely transported to different locations by a single arm of an individual user. In some embodiments, the viscous material dispensing system is able to be carried on the back of an individual user. In some embodiments, the viscous material dispensing system has a weight in a range of from about 10 pounds to about 20 pounds.

In some embodiments, the viscous material dispensing system includes a portability component selected from the group consisting of handles, straps, buckles, backpack straps, holsters, wheels, and combinations thereof. In some embodiments, the portability component is removable from the viscous material dispensing system.

In some embodiments, the portability component is partially or fully integrated with another component of the viscous material dispensing system. In some embodiments, the lid includes a portability component. In some embodiments, the pressure vessel includes a portability component.

In some embodiments, the portability component includes a securing component configured to secure the portability component to the viscous material dispensing system.

In some embodiments, the viscous material dispensing system includes a holster to hold the applicator when not in use.

In many embodiments, the flexible tube is physically connected to the lid. In some embodiments, the flexible tube is physically connected to the lid by a swivel joint. In some embodiments, the flexible tube is physically connected to the actuator by a swivel joint. In these embodiments, the swivel joint allows 360° rotation of the flexible tube.

In some embodiments, the flexible tube is physically located entirely exterior to the lid. In some embodiments, a portion of the flexible tube is physically located within the lid.

Generally, the viscous material dispensing system may include any applicator known in the art suitable to facilitate the viscous material dispensing system. The applicator allows a user to dispense the viscous material by actuating the applicator. In some embodiments, the applicator is able to be held and actuated with a single hand of an individual user. In some embodiments, the applicator is able to be held and actuated with two hands of an individual user.

In some embodiments, the applicator is selected from the group consisting of in-line applicators, pistol grip applicators, and combinations thereof. In some embodiments, the applicator is an in-line applicator. In some embodiments, the applicator is a pistol grip applicator.

In some embodiments, the applicator includes a nozzle through which the viscous material may be output. In some embodiments, the nozzle is symmetrical. In some embodiments, the nozzle is asymmetrical. In some embodiments, the nozzle includes a bias-cut tip. In some embodiments, the nozzle is removable for replacement. In some embodiments, the nozzle includes a cap to improve storage time of the viscous material within the viscous material dispensing system.

In many embodiments, the applicator includes an actuator. In these embodiments, actuation of the applicator dispenses the viscous material from the applicator. In some embodiments, the applicator includes an actuator selected from the group consisting of triggers, buttons, levers, and combinations thereof. In some embodiments, the actuator is depressed by a user.

In some embodiments, the applicator includes an adjustable portion. In some embodiments, the applicator includes an adjustable portion selected from the group consisting of rotatable portions, telescopic portions, adjustable stops for trigger travel, and combinations thereof.

In some embodiments, the applicator includes a rotatable portion configured to adjust the position of a bias-cut tip of a nozzle.

In some embodiments, the lid includes an aperture disposed therethrough, wherein the compressible container assembly is fluidically connectable to the applicator through the aperture of the lid and the flexible tube.

In some embodiments, the compressible container assembly, the aperture of the lid, the flexible tube, and the applicator are all in fluidic connection. Upon compression of the compressible container, viscous material is forced out of the compressible container assembly, through the aperture of the lid, through the flexible tube, and to the applicator. The viscous material may then be further dispensed from the applicator upon actuation of the applicator.

In some embodiments, the aperture disposed through the lid facilitates fluidic connection between the compressible container assembly, the flexible tube, and the applicator, but is not itself fluidically connected. Upon compression of the compressible container, viscous material is forced out of the compressible container assembly, through the flexible tube, and to the applicator. The viscous material may then be further dispensed from the applicator upon actuation of the applicator.

Described herein is a method of dispensing the viscous material from the viscous material dispensing system in a liquid form onto a target surface.

In some embodiments, dispensing the viscous material from the viscous material dispensing system includes fluidically connecting the lid to the compressible container assembly, receiving in the pressure vessel the compressible container assembly, sealing the pressure vessel with the lid, receiving in the pressure vessel the pressurized fluid, and actuating the applicator to dispense the portion of the viscous material from the actuator in the liquid form.

In some embodiments, there are time delays between one or more steps for dispensing the viscous material from the viscous material dispensing system. In some embodiments, fluidically connecting the lid to the compressible container assembly, receiving in the pressure vessel the compressible container assembly, sealing the pressure vessel with the lid, and receiving in the pressure vessel the pressurized fluid is completed in quick succession at an initial time to prime the viscous material dispensing system, while actuating the applicator to dispense the portion of the viscous material from the actuator in the liquid form is completed at a later time when the target surface is ready to receive the viscous material.

In some embodiments, once the viscous material dispensing system is primed with the viscous material, the viscous material remains within the viscous material dispensing system for a time in a range of from about 1 second to about 72 hours. In some embodiments, once the viscous material dispensing system is primed with the viscous material, the viscous material remains within the viscous material dispensing system for a time greater than about 72 hours. In these embodiments, there is no in-unit curing of the viscous material.

In some embodiments, once the viscous material dispensing system is primed with the viscous material, the viscous material remains within the viscous material dispensing system for a time of at least about 1 second, at least about 1 minute, at least about 5 minutes, at least about 10 minutes, at least about 20 minutes, at least about 30 minutes, at least about 40 minutes, at least about 50 minutes, at least about 1 hour, at least about 2 hours, at least about 4 hours, at least about 8 hours, at least about 10 hours, at least about 12 hours, at least about 16 hours, at least about 20 hours, at least about 24 hours, at least about 36 hours, at least about 48 hours, or at least about 60 hours.

In some embodiments, once the viscous material dispensing system is primed with the viscous material, the viscous material remains within the viscous material dispensing system for a time of at most about 1 minute, at most about 5 minutes, at most about 10 minutes, at most about 20 minutes, at most about 30 minutes, at most about 40 minutes, at most about 50 minutes, at most about 1 hour, at most about 2 hours, at most about 4 hours, at most about 8 hours, at most about 10 hours, at most about 12 hours, at most about 16 hours, at most about 20 hours, at most about 24 hours, at most about 36 hours, at most about 48 hours, at most about 60 hours, or at most about 72 hours.

In some embodiments, the viscous material dispensing system is capable of dispensing the portion of the viscous material within a time of less than about 5 minutes, less than about 4 minutes, less than about 3 minutes, less than about 2 minutes, or less than about 1 minute during continuous operation. In these embodiments, it is understood that the viscous material dispensing system is capable of high-throughput dispensing.

In some embodiments, the viscous material dispensing system is capable of dispensing all the viscous material within a time of less than about 5 minutes, less than about 4 minutes, less than about 3 minutes, less than about 2 minutes, or less than about 1 minute during continuous operation. In these embodiments, it is understood that the viscous material dispensing system is capable of high-throughput dispensing. As used herein, the term “high-throughput” means a dispensing rate of up to 5 mL/s.

In some embodiments, receiving in the pressure vessel the compressible container assembly includes enclosing the compressible container assembly wholly inside the pressure vessel.

In some embodiments, receiving in the pressure vessel the pressurized fluid compresses the compressible container. In some embodiments, receiving in the pressure vessel the pressurized fluid compresses the compressible container and results in a portion of the viscous material flowing from the compressible container assembly to the flexible tube. In some embodiments, receiving in the pressure vessel the pressurized fluid compresses the compressible container and results in a portion of the viscous material flowing from the compressible container assembly to the applicator.

Described herein is a method of using a viscous material dispensing system. The method includes using the viscous material dispensing system to dispense the viscous material in the liquid form onto a target surface.

In some embodiments, using the viscous material dispensing system includes: fluidically connecting the lid to the compressible container assembly, receiving in the pressure vessel the compressible container assembly, sealing the pressure vessel with the lid, receiving in the pressure vessel the pressurized fluid, and actuating the applicator to dispense the portion of the viscous material from the actuator in the liquid form.

Generally, the target surface may be any suitable surface known in the art that facilitates the method. In some embodiments, the target surface is selected from the group consisting of a horizontal surface, a vertical surface, an angled surface, and combinations thereof. In some embodiments, the target surface is selected from the group consisting of a ceiling, a wall, an interior wall, an exterior wall, a construction surface, a floor, and combinations thereof.

In some embodiments, the surface is smooth. In some embodiments, the surface is rough. In some embodiments, the surface is pre-textured. In some embodiments, the surface is a repaired surface. In some embodiments, the surface is a repaired surface, wherein the repaired surface is a smooth surface that is surrounded by a textured surface. In some embodiments, the surface has a texture selected from the group consisting of a knockdown texture, an orange peel texture, a popcorn texture, a primed surface, a painted surface, and combinations thereof.

In some embodiments, the target surface is a surface selected from the group consisting of a surface in a building and/or construction application, a surface in an interior trim work application, a wall, a floor, a ceiling, a door, a window, a gap therebetween, and combinations thereof.

In some embodiments, the target surface includes a material selected from the group consisting of glass, ceramic tile, porcelain tile, ceramic and porcelain tile, concrete, metals, aluminum, plastic, polyvinyl chloride (PVC), acrylonitrile butadiene styrene (ABS), wood, drywall, and combinations thereof.

Described herein is a compressible container assembly. The compressible container assembly includes a tube including a plurality of perforations and a compressible container. The compressible container includes a spout, an internal volume formed between walls of the compressible container, and a viscous material disposed in the internal volume. The compressible container is configured to receive a portion of the tube through the spout. A portion of the viscous material is forced out of the compressible container upon compression of the compressible container. The tube is configured to prevent a portion of the compressible container from collapsing upon compression of the compressible container.

Generally, the compressible container assembly may include any spout known in the art suitable to facilitate the compressible container assembly.

In some embodiments, the spout is sealed to walls of the compressible container. In some embodiments, the spout is heat-sealed to walls of the compressible container.

In some embodiments, the compressible container is configured to receive all of the tube through the spout. In these embodiments, the tube fits entirely in the compressible container. In some embodiments, the compressible container is configured to receive less than all of the tube through the spout. In these embodiments, the tube does not fit entirely in the compressible container.

In some embodiments, the spout includes a plurality of fluidically separated apertures therethrough. In some embodiments, the fluidically separated apertures are separated by an internal component of the spout (e.g., an internal wall). In some embodiments, the fluidically separated apertures are separated by a further component that is inserted into the spout.

In some embodiments, each aperture of the fluidically separated apertures is fluidically connected to a separate compartment of a plurality of fluidically separated compartments of the compressible container. In some embodiments, each aperture of the fluidically separated apertures is fluidically connected to a separate compressible container.

Generally, the compressible container assembly may include any tube including a plurality of perforations known in the art suitable to facilitate the compressible container assembly. In some embodiments, the plurality of perforations are present along at least about 80% of the longest dimension of the tube. In some embodiments, the plurality of perforations are present along at least about 90% of the longest dimension of the tube. In some embodiments, the plurality of perforations are present along at least about 95% of the longest dimension of the tube. In some embodiments, the plurality of perforations are present along at least about 99% of the longest dimension of the tube.

It was surprisingly discovered herein that the tube including a plurality of perforations could prevent a significant portion of the compressible container from collapsing upon compression of the compressible container. Other configurations without such perforations do not exhibit such preventions because high viscosity materials do not migrate to a single bottom opening of a dip tube. Without being bound by any particular theory, it is believed that the tube provides sufficient structure to keep the compressible container open upon compression of the compressible container, while the plurality of perforations allows the viscous material to flow through the tube upon compression of the compressible container. The tube also prevents a pinch shut-off.

In some embodiments, the tube includes one or more features to adapt a threading of the compressible container to a quick-lock connection on the lid.

In some embodiments, the tube is configured to include as many perforations as possible while still being structurally sound. In some embodiments, the tube includes perforations at any or every direction of the tube with respect to an axial axis of the tube. In some embodiments, the tube includes one or more protrusions (e.g., stanchions) that support the tube and help keep the perforations open.

In some embodiments, the tube includes perforations having a shape selected from the group consisting of geometric shapes, circles, rectangles, squares, quadrilaterals, asymmetrical shapes, and combinations thereof.

Generally, the compressible container assembly may include any compressible container known in the art suitable to facilitate the compressible container assembly. In some embodiments, the compressible container is in a form selected from the group consisting of bags, pouches, bottles, and combinations thereof.

In some embodiments, the walls include a material selected from the group consisting of polyolefins homopolymers and copolymers, polyethylene homopolymers and copolymers, polypropylene homopolymers and copolymers, metal foils, aluminum foils, and combinations thereof.

In some embodiments, the internal volume has a volume in a range of from about 470 mL to about 3800 mL.

In some embodiments, the internal volume has a volume of at least about 450 mL, at least about 470 mL, at least about 550 mL, at least about 650 mL, at least about 750 mL, at least about 850 mL, at least about 950 mL, at least about 1050 mL, at least about 1150 mL, at least about 1250 mL, at least about 1350 mL, at least about 1450 mL, at least about 1550 mL, at least about 1650 mL, at least about 1750 mL, at least about 1850 mL, at least about 1950 mL, at least about 2050 mL, at least about 2150 mL, at least about 2250 mL, at least about 2350 mL, at least about 2450 mL, at least about 2550 mL, at least about 2650 mL, at least about 2750 mL, at least about 2850 mL, at least about 2950 mL, at least about 3050 mL, at least about 3150 mL, at least about 3250 mL, at least about 3350 mL, at least about 3450 mL, at least about 3550 mL, at least about 3650 mL, or at least about 3750 mL. In some embodiments, the internal volume has a volume of at most about 470 mL, at most about 550 mL, at most about 650 mL, at most about 750 mL, at most about 850 mL, at most about 950 mL, at most about 1050 mL, at most about 1150 mL, at most about 1250 mL, at most about 1350 mL, at most about 1450 mL, at most about 1550 mL, at most about 1650 mL, at most about 1750 mL, at most about 1850 mL, at most about 1950 mL, at most about 2050 mL, at most about 2150 mL, at most about 2250 mL, at most about 2350 mL, at most about 2450 mL, at most about 2550 mL, at most about 2650 mL, at most about 2750 mL, at most about 2850 mL, at most about 2950 mL, at most about 3050 mL, at most about 3150 mL, at most about 3250 mL, at most about 3350 mL, at most about 3450 mL, at most about 3550 mL, at most about 3650 mL, at most about 3750 mL, or at most about 3800 mL.

In some embodiments, the internal volume includes a single compartment including a viscous material.

In some embodiments, the internal volume includes a plurality of fluidically separated compartments. In some embodiments, each compartment of the plurality of fluidically separated compartments includes a viscous material. In some embodiments, at least one compartment of the plurality of fluidically separated compartments does not include a viscous material.

In some embodiments, the viscous material in each compartment of the plurality of fluidically separated compartments is independently the same or different. In some embodiments, each viscous material in each compartment of the plurality of fluidically separated compartments is the same. In some embodiments, at least one viscous material in at least one compartment of the plurality of fluidically separated compartments is different from another viscous material in at least one compartment of the plurality of fluidically separated compartments. In some embodiments, each viscous material in each compartment of the plurality of fluidically separated compartments is different from the other viscous material(s) in the other compartment(s) of the plurality of fluidically separated compartments.

In some embodiments, the portion of the viscous material includes at least 50% of the viscous material. In some embodiments, the portion of the viscous material includes at least 80% of the viscous material.

In some embodiments, the portion of the viscous material includes at least about 50%, at least about 60%, at least about 70%, at least about 80%, at least about 90%, at least about 95%, or at least about 99% of the viscous material. In some embodiments, the portion of the viscous material includes at most about 60%, at most about 70%, at most about 80%, at most about 90%, at most about 95%, at most about 99%, or 100% of the viscous material.

In some embodiments, the portion of the compressible container includes at least about 50% of the internal volume. In some embodiments, the portion of the compressible container includes at least about 80% of the internal volume.

In some embodiments, the portion of the compressible container includes at least about 50%, at least about 60%, at least about 70%, at least about 80%, at least about 90%, at least about 95%, or at least about 99% of the internal volume. In some embodiments, the portion of the compressible container includes at most about 60%, at most about 70%, at most about 80%, at most about 90%, at most about 95%, at most about 99%, or 100% of the internal volume.

In many embodiments, the compressible container assembly is configured to be fluidically connectable to a viscous material dispensing system.

In some embodiments, the viscous material dispensing system includes a pressure vessel including a lid that is fluidically connected to an applicator by a flexible tube. The pressure vessel is sealable by the lid and configured to receive a pressurized fluid when sealed by the lid. The lid is fluidically connectable to the compressible container assembly. When the lid has been fluidically connected to the compressible container assembly and the pressure vessel has received the pressurized fluid, the pressurized fluid compresses the compressible container and actuation of the applicator dispenses a portion of the viscous material from the actuator in a liquid form.

In some embodiments, the compressible container assembly includes a mixing component for mixing the viscous materials from each compartment of the plurality of fluidically separated compartments. In these embodiments, the viscous materials from each compartment of the plurality of fluidically separated compartments are mixed in the compressible container assembly before being provided to the viscous material dispensing system.

In some embodiments, the viscous material dispensing system includes a mixing component for mixing the viscous materials from each compartment of the plurality of fluidically separated compartments. In some embodiments, the viscous material dispensing system includes a static mixer in the nozzle. In these embodiments, the viscous materials from each compartment of the plurality of fluidically separated compartments are mixed in the viscous material dispensing system before being dispensed from the viscous material dispensing system.

In some embodiments, the viscous material dispensing system includes a mixing component for mixing the viscous materials from each compartment of the plurality of fluidically separated compartments. In these embodiments, the viscous materials from each compartment of the plurality of fluidically separated compartments are mixed in the viscous material dispensing system before being dispensed from the viscous material dispensing system.

In some embodiments, the mixing component is located before, after, or within a component of the viscous material dispensing system selected from the group consisting of the compressible container assembly, the pressure vessel, the aperture of the lid, the flexible tube, the applicator, and combinations thereof.

In some embodiments, the mixing component is selected from the group consisting of void volumes, static mixing components, dynamic mixing components, and combinations thereof.

In some embodiments, the compressible container assembly includes a single compressible container. In some embodiments, the compressible container assembly includes a plurality of compressible containers.

In some embodiments, the compressible container assembly includes a plurality of compressible containers, wherein each compressible container includes a spout, an internal volume formed between walls of the compressible container, and a viscous material disposed in the internal volume. In some embodiments, the compressible container assembly includes a plurality of compressible containers, wherein at least one compressible container does not include a spout, an internal volume formed between walls of the compressible container, or a viscous material disposed in the internal volume.

In one embodiment of the present disclosure, provided herein is a viscous material dispensing system including a pressure vessel including a lid that is fluidically connected to an applicator by a flexible tube. The pressure vessel is sealable by the lid and configured to receive a pressurized fluid when sealed by the lid. The lid is fluidically connectable to a compressible container assembly including a compressible container including a viscous material disposed therein. When the lid has been fluidically connected to the compressible container assembly and the pressure vessel has received the pressurized fluid, the pressurized fluid compresses the compressible container and actuation of the applicator dispenses a portion of the viscous material from the actuator in a liquid form.

In some embodiments, the lid is fluidically connectable to each compressible container of the plurality of compressible containers. In some embodiments, the lid includes a single fluidic connection to be fluidically connectable to each compressible container of the plurality of compressible containers. In some embodiments, the lid includes a plurality of fluidic connections to be fluidically connectable to each compressible container of the plurality of compressible containers.

In some embodiments, the lid includes a lesser number of fluidic connections than the number of the plurality of compressible containers. In some embodiments, the lid includes a greater number of fluidic connections than the number of the plurality of compressible containers. In some embodiments, the number of the fluidic connections and the compressible containers is the same.

Also provided herein is a method of using a compressible container assembly. The method includes using the compressible container assembly to provide the viscous material to a viscous material dispensing system.

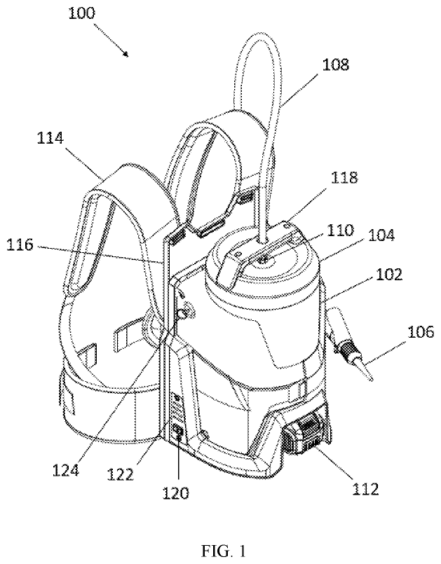

Turning now to the figures, FIG. 1 shows a perspective view of an exemplary viscous material dispensing system 100. The viscous material dispensing system includes a pressure vessel 102 including a lid 104 that is fluidically connected to an applicator 106 by a flexible tube 108 that includes a swivel joint 110 connecting the flexible tube 108 and the lid 104 through an aperture of the lid (not shown). The applicator 106 is depicted as an in-line applicator, but this depiction is non-limiting. The viscous material dispensing system 100 may include a compressible container assembly (not shown) sealed within the pressure vessel 102. The viscous material dispensing system 100 also includes a battery 112, a first portability component 114 (i.e., backpack straps) connected to the pressure vessel 102 by a securing component 116, a second portability component 118 (i.e., a handle), a power switch 120, an indicator LED 122, and a pressure relief mechanism 124.

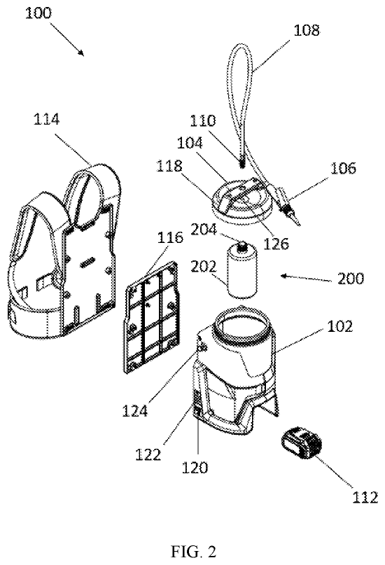

FIG. 2 shows an exploded view of the exemplary viscous material dispensing system 100. The same components are visible for FIG. 1, and they are described above. Further visible in this view is the aperture of the lid 126. Also further visible in this view is the compressible container assembly 200. The compressible container assembly 200 includes a compressible container 202, a spout 204, and a tube including a plurality of perforations (not shown). The compressible container 202 is depicted as a round compressible container, but this depiction is non-limiting.

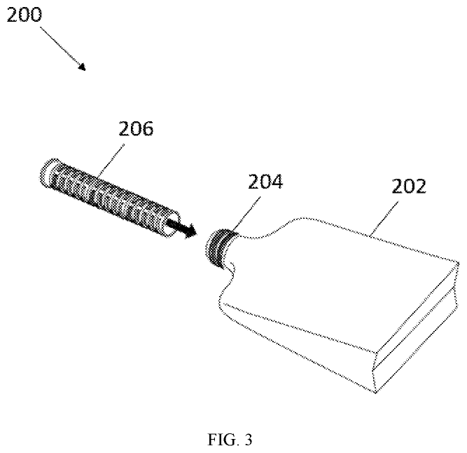

FIG. 3 shows an exploded view of the exemplary compressible container assembly 200. The compressible container assembly 200 includes a compressible container 202, a spout 204, and a tube including a plurality of perforations 206. As shown by the arrow, the tube including a plurality of perforations 206 may be inserted into the compressible container 202 through the spout 204. The compressible container 202 is depicted as a pouch compressible container, but this depiction is non-limiting.

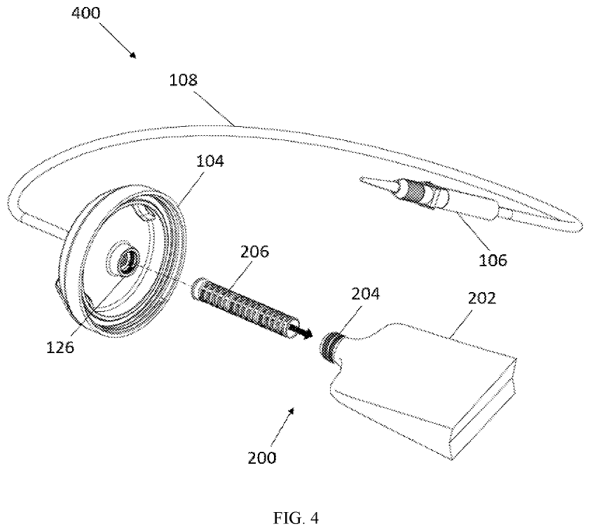

FIG. 4 shows a perspective view of a partially assembled viscous material dispensing system 400. The partially assembled viscous material dispensing system 400 corresponds to a portion of the viscous material dispensing system 100. Lid 104 is detachable from the viscous material dispensing system 100. The lid 104 remains attached to the flexible tube 108 including swivel joint (not shown), as well as the applicator 106. The applicator 106 is depicted as an in-line applicator, but this depiction is non-limiting. The bottom of the aperture of the lid 126 is visible in this configuration. The rest of the viscous material dispensing system 100, beyond the labeled elements, is not shown. The lid 104 is fluidically connectable to the compressible container assembly 200. The compressible container assembly 200 includes a compressible container 202, a spout 204, and a tube including a plurality of perforations 206. As shown by the arrow, the tube including a plurality of perforations 206 may be inserted into the compressible container 202 through the spout 204. The tube including a plurality of perforations 206 may be connected to the lid 104 via the aperture of the lid 126. The compressible container 202 is depicted as a pouch compressible container, but this depiction is non-limiting.

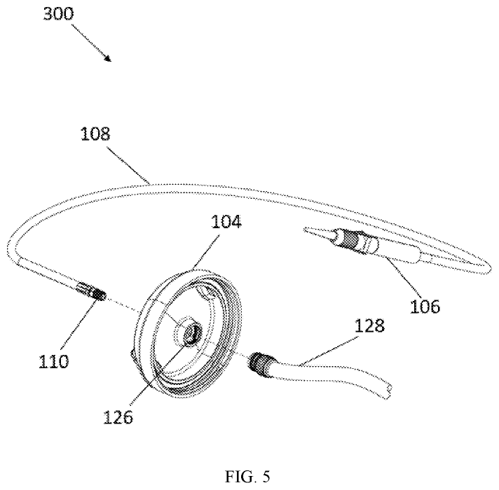

FIG. 5 shows an exploded view of an exemplary cleaning configuration 300 for the viscous material dispensing system 100. Lid 104 is detachable from the viscous material dispensing system 100. The lid 104 remains attached to the flexible tube 108 including swivel joint 110, as well as the applicator 106. The applicator 106 is depicted as an in-line applicator, but this depiction is non-limiting. The bottom of the aperture of the lid 126 is visible in this configuration. The rest of the viscous material dispensing system 100, beyond the labeled elements, is not shown. One end of a cleaning tube 128 may be connected to the lid 104 via the aperture of the lid 126. The other end of the cleaning tube 128 may be connected to a solvent source (not shown).

Embodiments of the present disclosure include:

Embodiment 1. A viscous material dispensing system including:
a pressure vessel including a lid that is fluidically connected to an applicator by a flexible tube, wherein the pressure vessel is sealable by the lid and configured to receive a pressurized fluid when sealed by the lid;
wherein the lid is fluidically connectable to a compressible container assembly including a compressible container including a viscous material disposed therein;
wherein, when the lid has been fluidically connected to the compressible container assembly and the pressure vessel has received the pressurized fluid, the pressurized fluid compresses the compressible container and actuation of the applicator dispenses a portion of the viscous material from the actuator in a liquid form.

Embodiment 2. The viscous material dispensing system of the preceding clause, wherein the viscous material includes a fluidic property under atmospheric pressure selected from the group consisting of:
a dynamic viscosity in a range of from about 15 Pa*s to about 70 Pa*s;
a static viscosity in a range of from about 175 Pa*s to about 700 Pa*s;
a yield viscosity less than about 100 Pa*s;
a yield stress less than about 300 Pa;
and combinations thereof.

Embodiment 3. The viscous material dispensing system of any preceding clause, wherein the pressurized fluid has a pressure in a range of from about 69,000 Pa to about 415,000 Pa.

Embodiment 4. The viscous material dispensing system of any preceding clause, wherein the viscous material is selected from the group consisting of curing compositions, one-component curing compositions, two-component curing compositions, three-component curing compositions, multi-component curing compositions, caulks, sealants, adhesives, and combinations thereof.

Embodiment 5. The viscous material dispensing system of any preceding clause, wherein the viscous material includes:
a sealant polymer; and
optionally a component selected from the group consisting of rheological additives, organic thickening agents, inorganic thickening agents, shear thinning thickening agents, pseudoplastic thickening agents, adhesion promoters, adhesives, pigments, dispersants, pigment dispersants, filler dispersants, fillers, detergents, non-ionic detergents, cationic detergents, anionic detergents, surfactants, non-ionic surfactants, cationic surfactants, anionic surfactants, biocides, mildew growth inhibitors, plasticizers, oils, process oils, freeze-thaw additives, volatile freeze-thaw additives, non-volatile freeze-thaw additives, pH modifiers, volatile pH modifiers, non-volatile pH modifiers, buffers, coalescing agents, defoamers, stabilizers, solvents, water, and combinations thereof.

Embodiment 6. The viscous material dispensing system of any preceding clause, wherein the pressurized fluid is selected from the group consisting of compressed air, compressed gas, compressed liquid, compressed CO₂, propellants, and combinations thereof.

Embodiment 7. The viscous material dispensing system of any preceding clause, further including a fluid compressor.

Embodiment 8. The viscous material dispensing system of any preceding clause, wherein the viscous material dispensing system includes a component requiring power, and wherein the viscous material dispensing system is configured to receive power from a power source selected from the group consisting of batteries, rechargeable batteries, non-rechargeable batteries, removable batteries, non-removable batteries, electrical outlets, renewable power sources, and combinations thereof.

Embodiment 9. The viscous material dispensing system of any preceding clause, wherein the viscous material dispensing system is cleanable without physical contact of the viscous material by a user, wherein the lid is fluidically connectable to a cleaning tube and the cleaning tube is fluidically connectable to a solvent source selected from the group consisting of water outlets, water containers, solvent outlets, solvent containers, and combinations thereof.

Embodiment 10. A method of cleaning the viscous material dispensing system of any preceding clause, the method including:
fluidically connecting the lid to a cleaning tube;
fluidically connecting the cleaning tube to a solvent source selected from the group consisting of water outlets, water containers, solvent outlets, solvent containers, and combinations thereof; and
flowing solvent from the solvent source to remove viscous material from the flexible tube and applicator.

Embodiment 11. The viscous material dispensing system of any preceding clause, wherein the viscous material dispensing system is portable and includes a portability component selected from the group consisting of handles, straps, buckles, backpack straps, holsters, wheels, and combinations thereof.

Embodiment 12. The viscous material dispensing system of any preceding clause, wherein the flexible tube is physically connected to the lid by a swivel joint and/or wherein the flexible tube is physically connected to the actuator by a swivel joint.

Embodiment 13. The viscous material dispensing system of any preceding clause, wherein the applicator is selected from the group consisting of in-line applicators, pistol grip applicators, and combinations thereof.

Embodiment 14. The viscous material dispensing system of any preceding clause, wherein the lid includes an aperture disposed therethrough, wherein the compressible container assembly is fluidically connectable to the applicator through the aperture of the lid and the flexible tube.

Embodiment 15. A method of dispensing the viscous material from the viscous material dispensing system of any preceding clause, the method including:
fluidically connecting the lid to the compressible container assembly;
receiving in the pressure vessel the compressible container assembly;
sealing the pressure vessel with the lid;
receiving in the pressure vessel the pressurized fluid; and
actuating the applicator to dispense the portion of the viscous material from the actuator in the liquid form.

Embodiment 16. A method of using a viscous material dispensing system including:
a pressure vessel including a lid that is fluidically connected to an applicator by a flexible tube, wherein the pressure vessel is sealable by the lid and configured to receive a pressurized fluid when sealed by the lid;
wherein the lid is fluidically connectable to a compressible container assembly including a compressible container including a viscous material disposed therein;
wherein, when the lid has been fluidically connected to the compressible container assembly and the pressure vessel has received the pressurized fluid, the pressurized fluid compresses the compressible container and actuation of the applicator dispenses a portion of the viscous material from the actuator in a liquid form,
the method including using the viscous material dispensing system to dispense the viscous material in the liquid form onto a target surface.

Embodiment 17. The method of the preceding clause, wherein the target surface is a surface selected from the group consisting of a horizontal surface, a vertical surface, an angled surface, and combinations thereof.

Embodiment 18. The method of any preceding clause, wherein the target surface is a surface selected from the group consisting of a surface in a building and/or construction application, a surface in an interior trim work application, a wall, a floor, a ceiling, a door, a window, a gap therebetween, and combinations thereof.

Embodiment 19. The method of any preceding clause, wherein the target surface includes a material selected from the group consisting of glass, ceramic tile, porcelain tile, ceramic and porcelain tile, concrete, metals, aluminum, plastic, polyvinyl chloride (PVC), acrylonitrile butadiene styrene (ABS), wood, drywall, and combinations thereof.

Embodiment 20. The method of any preceding clause, wherein using the viscous material dispensing system includes:
fluidically connecting the lid to the compressible container assembly;
receiving in the pressure vessel the compressible container assembly;
sealing the pressure vessel with the lid;
receiving in the pressure vessel the pressurized fluid; and
actuating the applicator to dispense the portion of the viscous material from the actuator in the liquid form.

Embodiment 21. A compressible container assembly, including:
a tube including a plurality of perforations; and
a compressible container including:
   a spout;
   an internal volume formed between walls of the compressible container; and
   a viscous material disposed in the internal volume;
wherein the compressible container is configured to receive a portion of the tube through the spout;
wherein a portion of the viscous material is forced out of the compressible container upon compression of the compressible container; and
wherein the tube is configured to prevent a portion of the compressible container from collapsing upon compression of the compressible container.

Embodiment 22. The compressible container assembly of the preceding clause, wherein the compressible container is configured to receive all of the tube through the spout.

Embodiment 23. The compressible container assembly of any preceding clause, wherein the plurality of perforations are present along at least about 80% of the longest dimension of the tube.

Embodiment 24. The compressible container assembly of any preceding clause, wherein the plurality of perforations are present along at least about 90% of the longest dimension of the tube.

Embodiment 25. The compressible container assembly of any preceding clause, wherein the compressible container is configured to be compressed at a pressure in a range of from about 69,000 Pa to about 415,000 Pa.

Embodiment 26. The compressible container assembly of any preceding clause, wherein the portion of the viscous material includes at least about 50% of the viscous material.

Embodiment 27. The compressible container assembly of any preceding clause, wherein the portion of the viscous material includes at least about 80% of the viscous material.

Embodiment 28. The compressible container assembly of any preceding clause, wherein the viscous material is selected from the group consisting of curing compositions, one-component curing compositions, two-component curing compositions, three-component curing compositions, multi-component curing compositions, caulks, sealants, adhesives, and combinations thereof.

Embodiment 29. The compressible container assembly of any preceding clause, wherein the viscous material includes:
a sealant polymer; and
optionally a component selected from the group consisting of rheological additives, organic thickening agents, inorganic thickening agents, shear thinning thickening agents, pseudoplastic thickening agents, adhesion promoters, adhesives, pigments, dispersants, pigment dispersants, filler dispersants, fillers, detergents, non-ionic detergents, cationic detergents, anionic detergents, surfactants, non-ionic surfactants, cationic surfactants, anionic surfactants, biocides, mildew growth inhibitors, plasticizers, oils, process oils, freeze-thaw additives, volatile freeze-thaw additives, non-volatile freeze-thaw additives, pH modifiers, volatile pH modifiers, non-volatile pH modifiers, buffers, coalescing agents, defoamers, stabilizers, solvents, water, and combinations thereof.

Embodiment 30. The compressible container assembly of any preceding clause, wherein the internal volume includes a plurality of fluidically separated compartments, wherein each compartment of the plurality of fluidically separated compartments includes a viscous material, wherein the viscous material in each compartment of the plurality of fluidically separated compartments is independently the same or different.

Embodiment 31. The compressible container assembly of the preceding clause, wherein the spout includes a plurality of fluidically separated apertures therethrough, wherein each aperture of the fluidically separated apertures is fluidically connected to a separate compartment of the plurality of fluidically separated compartments.

Embodiment 32. The compressible container assembly of any preceding clause, wherein the compressible container is in a form selected from the group consisting of bags, pouches, bottles, and combinations thereof.

Embodiment 33. The compressible container assembly of any preceding clause, wherein the walls include a material selected from the group consisting of polyolefins homopolymers and copolymers, polyethylene homopolymers and copolymers, polypropylene homopolymers and copolymers, metal foils, aluminum foils, and combinations thereof.

Embodiment 34. The compressible container assembly of any preceding clause, wherein the internal volume has a volume in a range of from about 470 mL to about 3800 mL.

Embodiment 35. The compressible container assembly of any preceding clause, wherein the portion of the compressible container includes at least about 50% of the internal volume.

Embodiment 36. The compressible container assembly of any preceding clause, wherein the portion of the compressible container includes at least about 80% of the internal volume.

Embodiment 37. The compressible container assembly of any preceding clause, wherein the compressible container assembly is configured to be fluidically connectable to a viscous material dispensing system.

Embodiment 38. A viscous material dispensing system including:
a pressure vessel including a lid that is fluidically connected to an applicator by a flexible tube, wherein the pressure vessel is sealable by the lid and configured to receive a pressurized fluid when sealed by the lid;
wherein the lid is fluidically connectable to the compressible container assembly of any preceding clause;
wherein, when the lid has been fluidically connected to the compressible container assembly and the pressure vessel has received the pressurized fluid, the pressurized fluid compresses the compressible container and actuation of the applicator dispenses a portion of the viscous material from the actuator in a liquid form.

Embodiment 39. A method of using a compressible container assembly including:
a tube including a plurality of perforations; and
a compressible container including:
a spout;
an internal volume formed between walls of the compressible container; and
a viscous material disposed in the internal volume;
   wherein the compressible container is configured to receive a portion of the tube through the spout;
wherein a portion of the viscous material is forced out of the compressible container upon compression of the compressible container; and
wherein the tube is configured to prevent a portion of the compressible container from collapsing upon compression of the compressible container,
the method including using the compressible container assembly to provide the viscous material to a viscous material dispensing system.

Embodiment 40. The method of the preceding clause, wherein the viscous material dispensing system includes
a pressure vessel including a lid that is fluidically connected to an applicator by a flexible tube, wherein the pressure vessel is sealable by the lid and configured to receive a pressurized fluid when sealed by the lid;
wherein the lid is fluidically connectable to the compressible container assembly;
wherein, when the lid has been fluidically connected to the compressible container assembly and the pressure vessel has received the pressurized fluid, the pressurized fluid compresses the compressible container and actuation of the applicator dispenses a portion of the viscous material from the actuator in a liquid form.

### Definitions.

Based upon the above discussion and illustrations, those skilled in the art will readily recognize that various modifications and changes may be made to the various embodiments without strictly following the exemplary embodiments and applications illustrated and described herein. For example, the viscous material dispensing system may be utilized to dispense a variety of materials. Further, the embodiments noted herein may be combined, and further embodiments may be separated. Such modifications do not depart from the scope of various aspects of the invention, including aspects set forth in the claims.

This written description uses examples to illustrate the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed disclosure. The term “consisting essentially of” occupies a middle ground between “comprising” and “consisting of”.

Where a disclosure or a portion thereof is defined with an open-ended term such as “comprising,” it should be readily understood that (unless otherwise stated) the description should be interpreted to also describe such a disclosure using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the disclosure are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “about” means plus or minus 10% of the value.

What is claimed is:

1. A viscous material dispensing system comprising:
a pressure vessel comprising a lid that is fluidically connected to an applicator by a flexible tube, wherein the pressure vessel is sealable by the lid and configured to receive a pressurized fluid when sealed by the lid;
wherein the lid is fluidically connectable to a compressible container comprising a compressible container comprising a viscous material disposed therein;
wherein, when the lid has been fluidically connected to the compressible container assembly and the pressure vessel has received the pressurized fluid, the pressurized fluid compresses the compressible container and actuation of the applicator dispenses a portion of the viscous material from the actuator in a liquid form.

2. The viscous material dispensing system of claim 1, wherein the viscous material comprises a fluidic property under atmospheric pressure selected from the group consisting of:
a dynamic viscosity in a range of from about 15 Pa*s to about 70 Pa*s;
a static viscosity in a range of from about 175 Pa*s to about 700 Pa*s;
a yield viscosity less than about 100 Pa*s;
a yield stress less than about 300 Pa;
and combinations thereof.

3. The viscous material dispensing system of claim 1, wherein the pressurized fluid has a pressure in a range of from about 69,000 Pa to about 415,000 Pa.

4. The viscous material dispensing system of claim 1, wherein the viscous material is selected from the group consisting of curing compositions, one-component curing compositions, two-component curing compositions, three-component curing compositions, multi-component curing compositions, caulks, sealants, adhesives, and combinations thereof.

5. The viscous material dispensing system of claim 1, wherein the viscous material comprises:
a sealant polymer; and
optionally a component selected from the group consisting of rheological additives, organic thickening agents, inorganic thickening agents, shear thinning thickening agents, pseudoplastic thickening agents, adhesion promoters, adhesives, pigments, dispersants, pigment dispersants, filler dispersants, fillers, detergents, non-ionic detergents, cationic detergents, anionic detergents, surfactants, non-ionic surfactants, cationic surfactants, anionic surfactants, biocides, mildew growth inhibitors, plasticizers, oils, process oils, freeze-thaw additives, volatile freeze-thaw additives, non-volatile freeze-thaw additives, pH modifiers, volatile pH modifiers, non-volatile pH modifiers, buffers, coalescing agents, defoamers, stabilizers, solvents, water, and combinations thereof.

6. The viscous material dispensing system of claim 1, wherein the pressurized fluid is selected from the group consisting of compressed air, compressed gas, compressed liquid, compressed CO₂, propellants, and combinations thereof.

7. The viscous material dispensing system of claim 1, further comprising a fluid compressor.

8. The viscous material dispensing system of claim 1, wherein the viscous material dispensing system comprises a component requiring power, and wherein the viscous material dispensing system is configured to receive power from a power source selected from the group consisting of batteries, rechargeable batteries, non-rechargeable batteries, removable batteries, non-removable batteries, electrical outlets, renewable power sources, and combinations thereof.

9. The viscous material dispensing system of claim 1, wherein the viscous material dispensing system is cleanable without physical contact of the viscous material by a user, wherein the lid is fluidically connectable to a cleaning tube and the cleaning tube is fluidically connectable to a solvent source selected from the group consisting of water outlets, water containers, solvent outlets, solvent containers, and combinations thereof.

10. A method of cleaning the viscous material dispensing system of claim 1, the method comprising:
fluidically connecting the lid to a cleaning tube;
fluidically connecting the cleaning tube to a solvent source selected from the group consisting of water outlets, water containers, solvent outlets, solvent containers, and combinations thereof; and
flowing solvent from the solvent source to remove viscous material from the flexible tube and applicator.

11. The viscous material dispensing system of claim 1, wherein the viscous material dispensing system is portable and comprises a portability component selected from the group consisting of handles, straps, buckles, backpack straps, holsters, wheels, and combinations thereof.

12. The viscous material dispensing system of claim 1, wherein the flexible tube is physically connected to the lid by a swivel joint and/or wherein the flexible tube is physically connected to the actuator by a swivel joint.

13. The viscous material dispensing system of claim 1, wherein the applicator is selected from the group consisting of in-line applicators, pistol grip applicators, and combinations thereof.

14. The viscous material dispensing system of claim 1, wherein the lid comprises an aperture disposed therethrough, wherein the compressible container assembly is fluidically connectable to the applicator through the aperture of the lid and the flexible tube.

15. A method of dispensing the viscous material from the viscous material dispensing system of claim 1, the method comprising:
fluidically connecting the lid to the compressible container assembly;
receiving in the pressure vessel the compressible container assembly;
sealing the pressure vessel with the lid;
receiving in the pressure vessel the pressurized fluid; and
actuating the applicator to dispense the portion of the viscous material from the actuator in the liquid form.

16. A method of using a viscous material dispensing system comprising:
a pressure vessel comprising a lid that is fluidically connected to an applicator by a flexible tube, wherein the pressure vessel is sealable by the lid and configured to receive a pressurized fluid when sealed by the lid;
wherein the lid is fluidically connectable to a compressible container assembly comprising a compressible container comprising a viscous material disposed therein;
wherein, when the lid has been fluidically connected to the compressible container assembly and the pressure vessel has received the pressurized fluid, the pressurized fluid compresses the compressible container and actuation of the applicator dispenses a portion of the viscous material from the actuator in a liquid form,
the method comprising using the viscous material dispensing system to dispense the viscous material in the liquid form onto a target surface.

17. The method of claim 16, wherein the target surface is a surface selected from the group consisting of a horizontal surface, a vertical surface, an angled surface, and combinations thereof.

18. The method of claim 16, wherein the target surface is a surface selected from the group consisting of a surface in a building and/or construction application, a surface in an interior trim work application, a wall, a floor, a ceiling, a door, a window, a gap therebetween, and combinations thereof.

19. The method of claim 16, wherein the target surface comprises a material selected from the group consisting of glass, ceramic tile, porcelain tile, ceramic and porcelain tile, concrete, metals, aluminum, plastic, polyvinyl chloride (PVC), acrylonitrile butadiene styrene (ABS), wood, drywall, and combinations thereof.

20. The method of claim 16, wherein using the viscous material dispensing system comprises:
fluidically connecting the lid to the compressible container assembly;
receiving in the pressure vessel the compressible container assembly;
sealing the pressure vessel with the lid;
receiving in the pressure vessel the pressurized fluid; and
actuating the applicator to dispense the portion of the viscous material from the actuator in the liquid form.
